(19) United States
(12) Patent Application Publication
(10) Pub. No.: US 2010/0103309 A1
(43) Pub. Date: Apr. 29, 2010

(54) METHOD AND SYSTEM FOR COMPRESSED IMAGING

(75) Inventor: Adrian STERN, Omer (IL)

Correspondence Address: OLIFF & BERRIDGE, PLC, P.O. BOX 320850, ALEXANDRIA, VA, 22320-4850, US

(73) Assignee: OPTICAL COMPRESSED SENSING, Omer (IL)

(21) Appl. No.: 12/605,866

(22) Filed: Oct. 26, 2009

Related U.S. Application Data
(63) Continuation-in-part of application No. PCT/IL2008/000555, filed on Apr. 27, 2008.

(51) Int. Cl. H04N 5/238; H04N 5/235; H04N 5/225

(52) U.S. Cl. 348/360; 348/369; 348/362; 348/E05.034; 348/E05.024

(57) ABSTRACT

An imaging system and method are presented for use in compressed imaging. The system comprises at least one rotative vector sensor, and optics for projecting light from an object plane on said sensor. The system is configured to measure data indicative of Fourier transform of an object plane light field at various angles of the vector sensor rotation.

### RELATED APPLICATIONS

The present invention claims priority from the U.S. Provisional Application No. 60/907,943, filed on Apr. 24, 2007, the disclosure of which is hereby incorporated by reference in its entirety.

### TECHNICAL FIELD

The invention is generally in the field of compressed or compressive imaging.

### BACKGROUND

Compressed imaging is a subfield of the emerging field of compressed or compressive sensing or sampling. Compressed imaging exploits the large redundancy typical to human or machine intelligible images in order to capture less samples than commonly captured. In contrast to the common imaging approach, in which a conventional image with a large number of pixels is first captured, and then, often, this image is loss-compressed digitally, the compressed imaging approach attempts to obtain the image data in a compressed way by minimizing the collection of redundant for some further task data. The further task may be visualization. In other words, the compressed imaging avoids collection of data which will not be of value for human viewing or for some machine processing. Thus, the compressed imaging uses sensing processes allowing production of only loss-compressed, when compared with conventional, images. This production step, if done, is called reconstruction. A few reconstruction methods are known. For examples, the following article may be consulted: E. J. Candes, J. Romberg and T. Tao, “Robust uncertainty Principles: Exact signal reconstruction from highly incomplete frequency information”, IEEE Transactions on Information Theory, vol 52(2), 489-509, February 2006 ([1]). This article is incorporated herein by reference. Image reconstruction from “incomplete” data is possible due that fact that common images are highly redundant, as we experience with conventional compression techniques (e.g. JPEG).

### General Description

There is a need in the art for compressed imaging techniques. The inventor presents a new technique that can be applied for example in scanning, inspection, surveillance, remote sensing, in visible, infrared or terahertz radiation imaging. The technique may utilize at least one pixel sensor extending in one dimension (vector sensor), and a relative rotation between the imaged scene and the sensor (e.g. by moving (rotating) the sensor relatively to the imaged scene). It should be noted that the relative rotation between the image scene and the sensor is not necessarily obtained by rotation of the sensor (and of the associated optical elements, cylindrical lens or slit as will be described below). The image can be rotated optically using a prism and/or mirror, while the sensor is kept static; or both the image and the sensor are moved (rotated) one with respect to the other.

Pixels of the vector sensor(s) are typically arranged along a straight line, although this is not required. Different pixel subsets may be arranged along parallel lines and shifted by a non-whole number of pixels relatively each other and/or be sensitive to different wavelengths. The sensor is preceded by optics which projects on the sensor a signal (a field, for example the intensity field) indicative of the 2D Fourier transform of the object plane field along the dimension of the sensor (1D Fourier field). Due to the motion of the sensor and/or the image, a series of such 1D field or field strips is obtained, and due to the rotation, the series includes field strips extending in various directions. Thus, the strips can cover 2D Fourier space. However, the spatial frequencies of the object plane field, which contribute to at least one of the sensor measurements, are distributed non-uniformly in orthogonal spatial frequency coordinates (i.e. in the 2D Fourier space): spatial frequencies with larger magnitudes are separated by longer arcs, i.e. by larger spatial frequency distances, in the dimension of rotation. The full set of measurements may be augmented by one of reconstruction processes so that a total number of pixels, which will be shown in the reconstructed image, will be greater than the total number of pixels measured within the series.

It should be noted that using vector sensor(s) may be especially preferable if imaging is to be performed in those wavelength regions, in which matrix pixel sensors are expensive.

As well, matrix pixel sensors may be effectively utilized within the inventor's technique. If this is the case, optics is still setup to project on the matrix sensor a series of “one-dimensional” signals. Imaging can be performed not by all pixels of the matrix at a time, but by a rotating pixel vector, i.e. “vector trace”, within the matrix. Selection or definition of current read-out pixel vector can be done electronically. Imaging with a matrix sensor presents one of the ways to avoid physical rotation of the vector sensor; however, elements or parts of projecting optics still may need to be rotated. The imaging scheme relying on the use of a matrix sensor may help to save energy, increase sensor lifetime, and generate information-dense image data. These properties may be of high value in field measurements or in surveillance as they may relax memory and data transmission resources requirements and imaging system servicing requirements.

The following should be understood with respect to the motion of the vector pixel sensor and vector pixel trace in case of the pixel matrix sensor:

First, in those cases, in which the motion of the sensor relatively the imaged scene is reduced to simple rotation, the sensed spatial frequencies form a regular star in the 2D Fourier space. In some embodiments, the star is at least 16-pointed. The star may be at least 32-pointed. The star envelope is a circle.

Second, the motion may have components other than rotation. For example, the imaging system may be carried by an airplane. In this case, Fourier coefficients acquire a phase shift proportional to the airplane velocity. It should be understood that the unshifted phases can be restored if the motion is known.

Third, in case of an electronic control of read-out pixel vector, the length of the vector pixel trace typically varies for a given pixel non-circular matrix shape, depending on the direction or rotation angle of the pixel vector. In particular, vector trace length will vary with the most typical pixel matrix—rectangular, if all pixels are read-out along sensed directions. However, it should be understood, that not all pixels of a pixel vector, on which light is projected, have in fact to be read-out or kept in memory, in both cases—of the vector sensor(s) and of the matrix sensor. Hence, in either of these cases, star “rays” may be of close lengths or of significantly different lengths. For example, in some embodiments a ratio of the length of the shortest “ray” of the star to the length of the longest “ray” of the star is less than 0.65 or even 0.5, and in some embodiments this ratio is larger than 0.75 or even 0.9.

Additionally, irregularities of the star shape may be associated with variations in angular and radial sampling pitch. In other words, the pitches do not have to be constant. They may be selected to match specific application data acquisition goals, which for example may be to collect spatial frequencies more densely if sensor is oriented in a certain direction, so as to image specific object features. Non-regular (non equidistant) angular or radial sampling may permit better modeling of the acquisition process. For instance, the angular steps can be adapted to capture the Fourier samples on a pseudo-polar grid, which may simplify the reconstruction process and/or may improve its precision. For example, the grid may be selected for optimal presentation of image at the common rectangular grid.

In a broad aspect of the invention, there is provided an imaging system for use in compressed imaging. The system may include at least one pixel sensor having an array of pixels and an optical unit comprising an imaging optics for, projecting light indicative of an imaged scene of an object plane on the sensor, and may be be configured and operable to provide a relative rotation between the imaged scene and a sensor plane, sensed light being therefore indicative of Fourier transform of an object plane light field at various angles of the relative rotation.

The system may include at least one rotative optical element, such as prism and mirror(s), vector sensor and optics, laterally rotating and projecting light from an object plane on the sensor, and be configured to measure data indicative of Fourier transform of an object plane light field at various angles of the vector sensor rotation.

The system may include a pixel matrix sensor and optics, compressively projecting light information (i.e. visual information or image itself) from an object plane on a pixel vector of the sensor, and be configured to affect a direction of the light projection and measure data indicative of Fourier transform of the object plane light field by matching an orientation of the pixel vector within the pixel matrix and the direction of the light projection.

The system may include at least two vector sensors arranged in a staggered configuration. The system may include at least two vector sensors arranged in a stack configuration. The system may include at least two vector sensors with sensitivity peak wavelengths differing for more than 20% of a shortest of the sensitivity peak wavelengths.

The optical unit may include a slit. It may include a cylindrical lens and/or mirror. The optical unit may include a 4-f optical element arrangement. It may include a 2-f optical element arrangement. The system may include a source of radiation for directing emitted radiation onto the object plane, the source of radiation being configured for producing coherent or incoherent radiation. It may include at least one beam splitter and be configured as a holographic system.

The vector sensor may have a sensitivity peak between 90 GHz and 3 THz. The sensitivity peak may be in infrared range with a frequency higher than 3 THz. The peak may be in visible range.

The system may include a control unit configured to initiate measurements by said at least one sensor at predetermined angles of the relative rotation. Alternatively or additionally, the control unit may be configured to reconstruct an image from data measured by the sensor at various angles of its rotation or at various pixel orientations within the pixel sensor. A set of the various angles may be predetermined. The control unit may be configured to reconstruct an image using different optimization techniques such as minimization of total variation optimization technique or a l₁ normalization optimization (e.g. minimization) technique from data measured by the sensor for various angles of its rotation, or a combined l₁ and l₂ optimization technique from data measured by the sensor for various angles of its rotation.

Reconstruction may utilize a maximum a posteriori estimation technique. Reconstruction may be done using a penalized maximum likelihood estimation technique.

In some embodiments, the system comprises a rotative mount associated with at least one of an object, the sensor and the optical unit for implementing said relative rotation.

In some embodiments, the optical unit comprises relay optics for rotating an image being projected relative to the sensor and object planes.

There is also provided, an imaging system for use in compressed imaging, the system comprising a pixel matrix sensor and optics compressively projecting light information, indicative of an image of an object, from an object plane on a pixel vector of said sensor, the system is configured to affect a direction of light projection; said light projection being a indicative of the 2D Fourier transform of the object plane field, and measure data indicative of Fourier transform of the object plane light field by matching an orientation of said pixel vector within the pixel matrix and the direction of the light projection.

In another broad aspect of the invention, there is provided a method for use in compressed imaging, the method including reconstructing an image from data indicative of Fourier transform of an object plane field, a set of spatial frequencies of the data having a star configuration in two-dimensional spatial frequency space, an envelope of the star being of a substantially circular shape.

The method may include reconstructing an image from data indicative of Fourier transform of an object plane light field, a set of spatial frequencies of the data having a star configuration in two-dimensional spatial frequency space, a ratio between a length of a shortest star ray a and a length of a longest ray being less than 0.65 or larger than 0.75.

The reconstruction may be done using minimization of total variation optimization technique or a l₁ minimization technique.

In yet another broad aspect of the invention, there is provided a method for use in compressed imaging, the method including sequentially projecting light information, indicative of an image of an object from an object plane on various directions and/or various angles within a rotation plane of a rotative vector sensor and rotating the vector sensor so as to measure data indicative of Fourier transform of the object plane field by the sensor for the various directions of the projected light.

In yet another broad aspect of the invention, there is provided a method for use in compressed imaging, the method including sequentially compressively projecting light information, indicative of an image of an object, from an object plane on various directions within a pixel sensor plane and measuring data indicative of Fourier transform of the object plane field for the various directions by a pixel vector within the pixel matrix.

### BRIEF DESCRIPTION OF THE DRAWINGS

In order to understand the invention and to see how it may be carried out in practice, a few embodiments of it will now be described, by way of non-limiting example only, with reference to accompanying drawings, in which:

FIG. 1A shows an example of a star-shaped spatial frequency set suitable for realization of compressed imaging scheme according to the invention;

FIGS. 1B and 1C present an original image and an image reconstructed from the set of Fourier coefficients mapped in FIG. 1A;

FIG. 2 shows an example of an imaging system usable for compressed imaging with coherent light in accordance with the invention;

FIGS. 3A and 3B illustrate compressed imaging simulation performed for the system of FIG. 2;

FIG. 4 shows an example of an imaging system usable for imaging with incoherent light according to the invention;

FIG. 5 presents an exemplary arrangement of multiple vector sensors for use in various imaging systems of the invention;

FIGS. 6A-6D illustrate compressed imaging simulations performed for the system of FIG. 4 and for a conventional linear scanning system;

FIGS. 7A-7C show examples of holographic imaging systems usable for compressed imaging according to the invention;

FIG. 8 shows an example of an imaging system using a pixel matrix sensor in accordance with the invention;

FIG. 9A illustrates a conventional example of an imaging reconstruction technique of a set projected image into a single frame;

FIG. 9B illustrates an example of an imaging reconstruction technique of a set projected image into a single frame according to the technique of the present invention;

### DESCRIPTION OF EMBODIMENTS

In this section, first, some mathematical ideas applicable within the invented technique are illustrated, and then examples of various suitable optical systems are presented.

Typically, for an image f[n,m] defined on N×N pixel (n=1, 2 . . . N, m=1, 2 . . . N) an equivalent number N×N of Fourier coefficients is needed for reconstruction of the image by direct means (e.g. by inverse Fourier transform). But, in the compressed imaging framework, satisfactory reconstruction can be obtained by using appropriate nonlinear recovery algorithms applied to only part of the conventionally needed. Fourier coefficients. As mentioned above, Fourier coefficients, which will be directly or indirectly measured by the moving sensor and its optical system, will be non-uniformly distributed in the Fourier space, and low spatial frequency components will be sampled denser than high spatial frequency components.

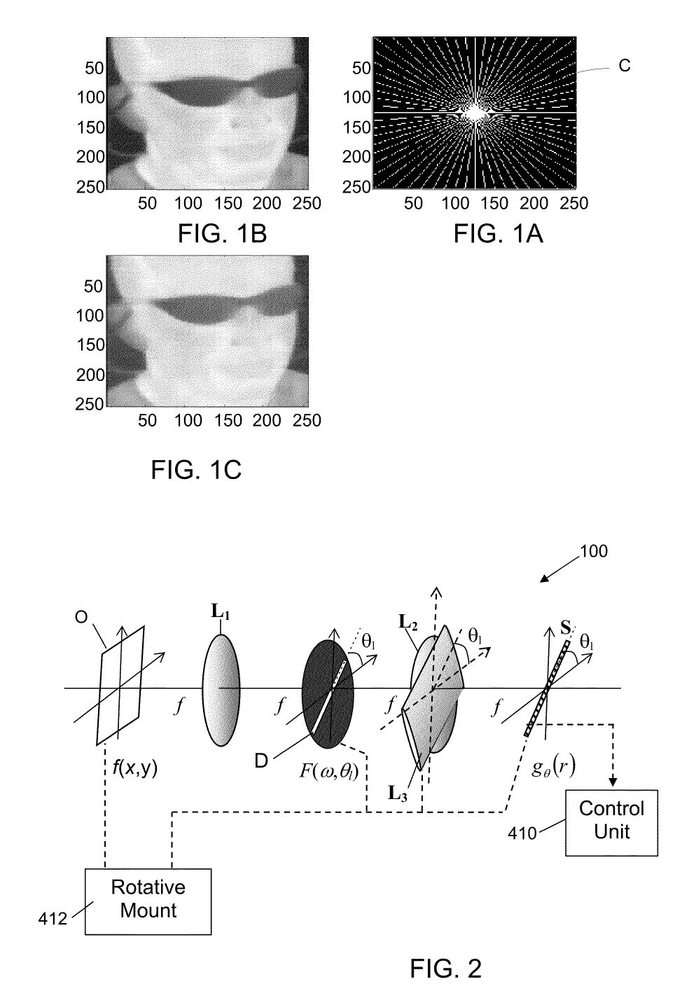

In FIG. 1A there is shown an example of a set of spatial frequencies, which is distributed in such a way. Another distribution of this kind was presented in [1]. The set of FIG. 1A includes L=32 radial lines in the Fourier plane (spatial frequency plane); radial lines are inclined with different polar angles

$${θ}_{l} = l \frac{π}{L} , l = 0 … ( L - 1 ) ,$$

relatively the horizontal axis. Along each of the radial lines, frequencies of the set are distributed uniformly. The total number of frequencies on each radial line is 256; frequencies lie within a circle C in the illustration and satisfy the inequality |ω|≦ωₘₐₓ.

When Fourier coefficients of the image are known at such a set, the image may be reconstructed. This is illustrated by FIGS. 1B and 1C. The first of these images is “conventional”: it is the original infrared image of the inventor. This image has 256 by 256 pixels. The second of these images is reconstructed from only 256×32 Fourier coefficients F(ω, θₗ), {θₗ}ₗ₌₀³¹, determined from the first image. Although the set {F(ω, θₗ)}ₗ₌₀^{L-1} with 256 frequency values in each of 32 radial lines covers only 12.5% of the original Fourier set, the original image could be reconstructed essentially completely as seen from FIG. 1C. In this example, the reconstruction was carried out digitally by the minimization of the total variation optimization technique:

min∥D\hat{f}∥₁ subject to \hat{F}(ω,θₗ)=F(ω,θₗ) for all {θₗ}ₗ₌₀^{L-1},

where ∥•∥ₗ denotes the l₁ norm and D defines the finite difference operator.

In more detail, the following minimization was done by the inventor:

$${min}_{\hat{f}} {\sum }_{n , m = 1}^{N - 1} \vert D \hat{f} [ n , m ] \vert subject to \hat{F} ( ω , {θ}_{l} ) = F ( ω , {θ}_{l} ) , \\ \vert ω \vert \leq {ω}_{max} for all {\{ {θ}_{l} \}}_{l = 0}^{L - 1} ,$$

where the finite difference operator D was given by D\hat{f}[n,m]=\sqrt{|\hat{f}[n+1,m]−\hat{f}[n,m]|²+|\hat{f}[n,m+1]−\hat{f}[n,m]|²} and \hat{F} denotes the Fourier transform of the reconstructed image \hat{f}. Basically, the reconstruction algorithm seeked a solution \hat{f} with minimum complexity—defined here as total variation

$${\sum }_{n , m = 1}^{N - 1} \vert D \hat{f} [ n , m ] \vert$$

-and whose Fourier coefficients over the radial strips {\hat{F}(ω,θₗ)}ₗ₌₀^{L-1} matched those found from the original image {F(ω,θₗ)}ₗ₌₀^{L-1}. The reconstruction criterion used by the inventor differed from the criterion used in [1] in that only spatial frequencies within the circle |ω|≦ωₘₐₓ were used for reconstruction by the inventor. This criterion used by the inventor relates to the technique with which sets of Fourier coefficients can be obtained by compressed imaging.

In accordance with the technique of the invention, direct or indirect measurements of the Fourier transform of the object field may be done with a rotationally moving vector sensor and provide a suitable set of spatial frequencies and Fourier coefficients for satisfactory reconstruction.

Referring to FIG. 2, there is shown an exemplary imaging system 100 configured for obtaining a desired set of field Fourier coefficients for the compressed imaging reconstruction with coherent light. Imaging system 100 samples the Fourier plane by using the common 4-f configuration. The system includes spherical lenses L₁, L₂ and a cylindrical lens L₃ with focal lengths fₗ, a slit D, and a line light sensor S. The light sensor, together with lens L₃ and slit D, or an object O, which is to be imaged, may be setup on a rotative mount 412. This mount 412 may form a part of the imaging system. System 100 is arranged in such a way that a series of radial lines in the Fourier plane of the object can be masked out and then Fourier transformed optically. Object O is positioned at distance fₗ from lens L₁ and is coherently illuminated; the object-reflected field is presented by function f(x,y). (Accordingly, the imaging system may include a source of coherent illumination, such as a laser). Hence, the function f(x,y) is two-dimensionally (2D) Fourier transformed by lens L₁. Slit D located at distance 2fₗ from the object and (currently) aligned with in-plane angle θₗ. It filters out the radial Fourier spectrum F(ω,θₗ). The following lenses L₂ and L₃ are conventional one-dimensional (1-D) optical Fourier transformers. Lens L₃, which is perpendicular to the slit, performs a 1-D Fourier transform of the masked Fourier spectrum, and lens L₂ projects it on the vector sensor S. Thus, the sensor captures the 1-D Fourier transform of the radial strip in the Fourier domain with orientation θₗ; that is the vector sensor measurement can be written as g_{θ}_{ₗ}(r)=ℑ_{ω}{F(ω,θₗ)}, |ω|≦ωₘₐₓ, where ℑ_{ω} denotes the one-dimensional (1-D) Fourier operator in the radial ω direction. By selecting the finite length of the slit L_{M}, the maximum measured radial frequency of {F(ω,θₗ)}ₗ₌₀^{L-1} can be defined as ωₘₐₓ=2πL_{M}/λfₗ, where λ is the wavelength of the coherent light and fₗ is the focal length of lens L₁. As a result the measured spatial frequency samples lay in a circle, similar to circle C shown in FIG. 1A. From the measured field g_{θ}_{ₗ}(r) the respective Fourier strip F(ω,θₗ) can be obtained, by simply inverse Fourier transforming the measured field numerically. By rotating the imaging system (or the vector sensor, the cylindrical lens, and the slit) with respect to the object, a desired number (e.g. L) exposures can be taken, capturing g_{θ}_{ₗ}(r) for all {θₗ}ₗ₌₀^{L-1}. Then, the 1-D Fourier transform along the radial lines are taken for all {g_{θ}_{ₗ}(r)}ₗ₌₀^{L-1} yielding the set of required radial Fourier samples {F(ω,θₗ)}ₗ₌₀^{L-1}.

It should be noted that if the vector sensor is an intensity sensor, then measurements {g_{θ}_{ₗ}(r)}ₗ₌₀^{L-1} need to be nonnegative in order not to lose information. This may be guaranteed if the object field has a sufficiently large dc component. Otherwise, various method can be used to avoid negative g_{θ}_{ₗ}(r) values. One way of doing this is by biasing the field at the recorder, for example, by superimposing to g_{θ}_{ₗ}(r) a coherent plane wave with measured or predetermined intensity.

Also, it should be remembered that system 100 is just a representative example. Other variations of the 4-f system, or equivalent systems can be utilized (see for example J. W. Goodman, “Introduction to Fourier optics”, chapter 8, or J. Shamir, “Optical systems and processing”, SPIE Press, WA, 1999, chapters 5 and 13 and chapters 5 and 6). As well, different implementations of the 1D Fourier transform may be used (see for example J. Shamir, “Optical systems and processing”, chapter 13). Generally, optics usable in the inventor's technique may include such optical elements as mirrors, prisms, and/or spatial light modulator (SLM).

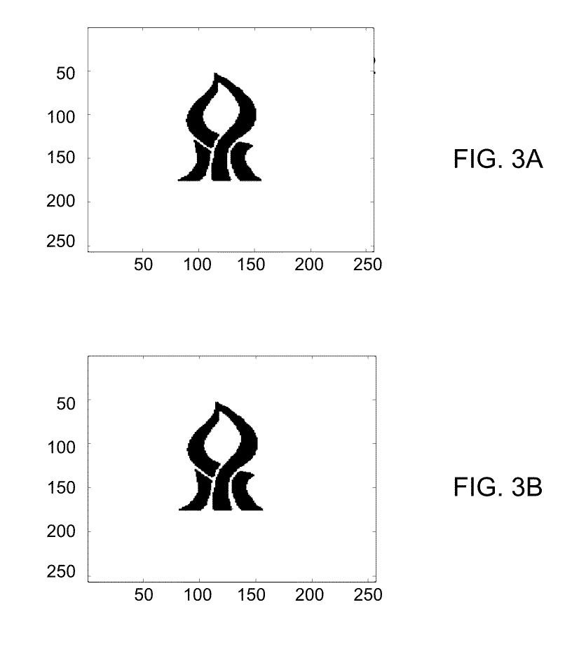

FIGS. 3A and 3B illustrate compressed imaging simulation performed for the system described in FIG. 2. The original object is shown in FIG. 3A. Its size was assumed to be 2.56×2.56 mm². The vector sensor was assumed to have 256 pixels of size 10 μm. The slit length was L_{M}=1 cm, its width was 39 μm. The focal length was fₗ=20 cm, illumination wavelength was λ=0.5 μm, and lenses' apertures were 5 cm each. The object was captured with L=25 exposures taken with θₗ in steps of 7.2 degrees. It was assumed that the object was still and that the rotation of the sensor was controlled by an appropriate control unit 410, so that images were taken at predetermined angles or that those angles were measured by the control unit 410. (The control unit 410 may be based on, for example, a special purpose computing device or a specially programmed general task computer). In the simulated experiment, the maximal radial frequency was ωₘ=2πL_{M}/λfₗ=2π·10⁵ rad/m. The achieved reconstruction is demonstrated in FIG. 3B. The image was completely reconstructed although the number of measured pixels was 25×256, which is more than 10 times less than the number of pixels in the image of FIG. 3A. Hence, a compression rate of c=10.24 was obtained by optical means only.

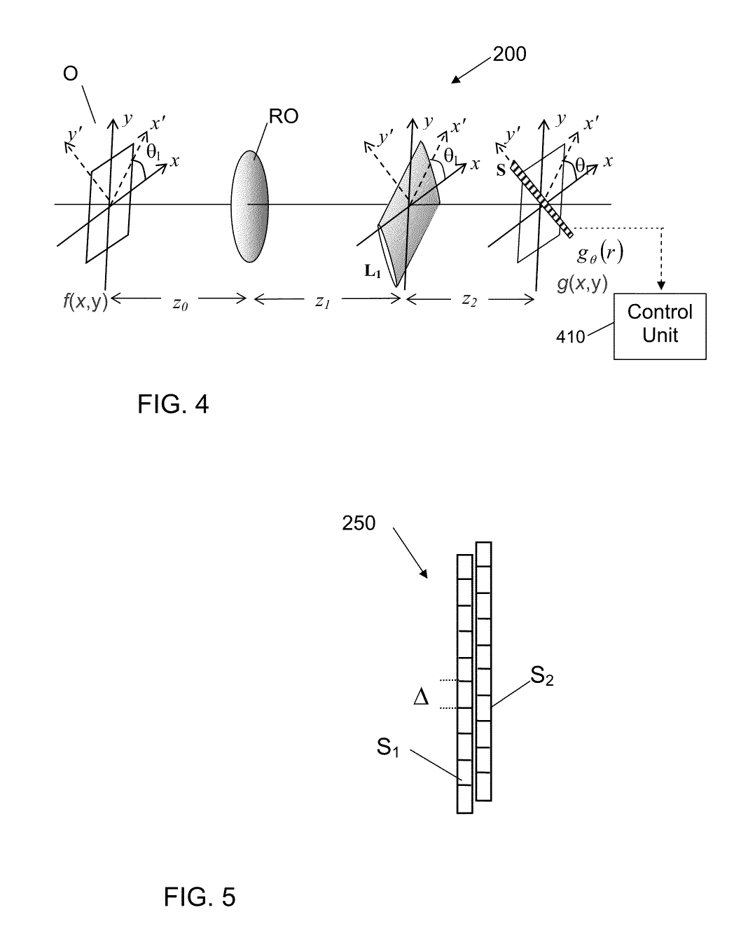

Referring to FIG. 4, there is shown an exemplary imaging system 200 suitable for use with incoherent light. System 200 includes a cylindrical lens L₁ and a vector sensor S. It also includes optional relay optics RO (e.g., magnifying lens set, optical aberration setup, or anamorphic lenses for collimating light in x′ direction, as described L. Levi, “Applied Optics”, John Wiley and Sons Inc., NY, Vol. 1, pp. 430, 1992). Lens L₁ projects object O on the sensor. Particularly, lens L₁ is aligned with and defines an x′ axis, which is in-plane rotated by angle θₗ with respect to the x axis selected in object plane. With the imaging condition fulfilled in the y′ direction, the system performs an integral projection of field f(x′,y′) on the y′ axis (see L. Levi, Applied Optics, John Wiley and Sons Inc., NY, Vol. 1, pp. 430, 1992, if needed). Linear sensor S, aligned with the y′ axis, captures the line integral

g(r=y′)=K∫f(x′,M_{y}y′)dx′

where K is a normalization factor and M_{y} defined the lateral magnification along y′. This integral, which is proportional to the projection of f(x′,y′) on y′, can be recognized as a Radon transform. According to the “central slice theorem” the Radon transform is the 1-D Fourier transform of the slice F(ω,θₗ). Therefore, the intensity measured by sensor S is g_{θ}_{ₗ}(r)=g(r=y′)=ℑ_{ω}{F(ω,θₗ)}, and F(ω,θₗ) can be obtained by inverse Fourier transforming the measured field g_{θ}_{ₗ}(r). By rotating the imaging system with respect to the object and taking L exposures, field g_{θ}_{ₗ}(r) is captured for all {θₗ}ₗ₌₀^{L-1}. Alternatively, the set of projections g_{θ}_{ₗ}(r) can be obtained by generating rotating image at angles {θₗ}ₗ₌₀^{L-1} at the output of properly designed relay optics to obtain laterally rotated images (e.g., using Dove prisms or other combination of mirrors, prisms and reflecting or refracting components), eliminating a need for rotating the sensor thus enabling to keep the sensor stable.

It should be noted herein that, although above description separates steps of object Fourier representation calculation and reconstruction, in practice these operations may be fused together: the Fourier calculation and reconstruction may be presented as a single operation, which will utilize the 2D Fourier transform inexplicitly. Further, this single operation may be described without reference to Fourier transform. It could be said, that the system in FIG. 3 captures linear projections of the image and thus optically performs the Radon transform, and that the further reconstruction is done by some constrained inverse Radon transform. It should be understood, however, that despite changes in the reconstruction process, the field indicative of the Fourier transform of the object is still measured.

Referring to FIG. 5, there is shown an exemplary staggered arrangement 250 of two vector sensors S₁ and S₂ which may be used for improving the measurement resolution in either of the above detailed imaging approaches: to this end, arrangement 250 may replace single sensor S in either system 100 or 200. Such a replacement makes use of the field extending perpendicularly to the sensor: the intensity is sensors are exposed to the same intensity distribution, but sample this distribution differently. Thus the staggered configuration permits an overall finer sampling: the two stage staggered sensor permits sampling at interval Δ/2 instead of Δ, where Δ denotes the vector sensor pixel size. Multiple (more than two) staggered sensors may be utilized if even a finer resolution is desired.

Similarly to the case with staggered sensors, the vector sensor can be replaced by multiple adjacent sensors sensitive to different wavelengths, which together with proper optical relay can implement a multispectral imaging system. In case of measurements with coherent light, the wavelength of coherent illumination may be tuned.

As well, a stack of (aligned) vector sensors can be used to collect more light even of the same wavelength. Since the projected signal is “one-dimensional”, aligned pixels will produce the same or close measurements.

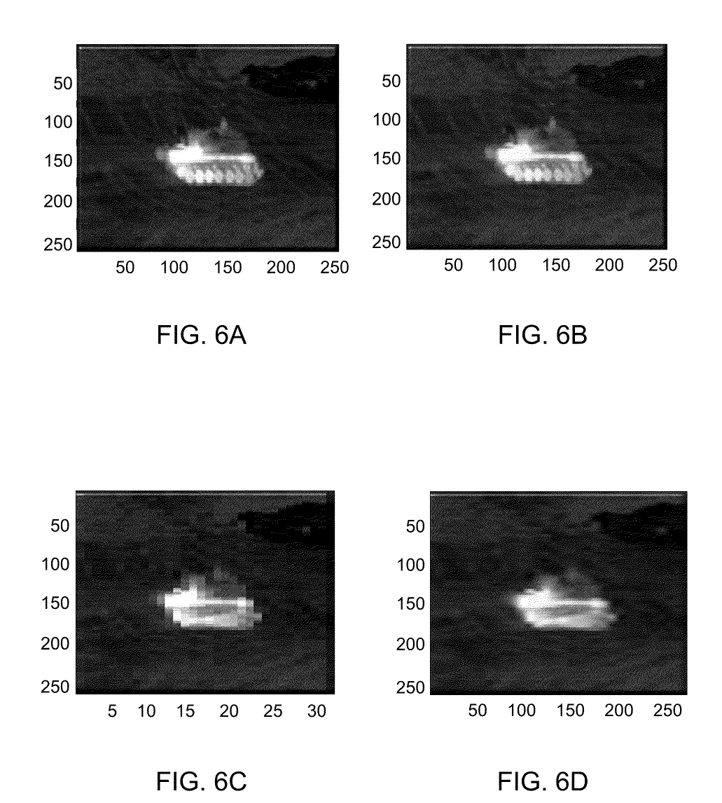

Referring to FIGS. 6A-6D, they present results of numerical simulations performed by the inventor for the system described above with reference to FIG. 4 and for a conventionally arranged scanning system. In FIG. 6A there is shown an object located at a distance 300 m from the imaging system. The figure has 256×256 pixels. Relay optics is assumed to perform a lateral magnification of 0.001. It could also be used for preconditioning the incoming signal for example by filtering or polarizing. Lens L₁ was assumed to have the magnification of 0.2 in y′ direction and an aperture of 70 mm. Distances z₁ and z₂ in FIG. 4 were assumed to be 0.5 m and 0.04 m, respectively. The system was assumed to operate in long wave infrared regime with an average wavelength λ̅=10 μm. Vector sensor S had 256 pixels of size Δ=20 μm. The resolvable spatial frequency in the object plane is sensor limited by its maximum value ωₘ=2π·0.001·0.2/Δ=62.6 rad/m. The sensor scanned the 2-D Fourier spectrum of the image with a rotational motion. FIG. 613 shows a result of image reconstruction based on only L=32 exposures, capturing the 32 radial strips F(ω,θₗ) of 2D Fourier domain as shown in FIG. 1A. The reconstruction appears to be of a high quality. If the scanning would be performed conventionally, i.e. by a linear sensor moving translationally, 256 exposures would have to be made for obtaining the conventionally used grid of Fourier coefficients. Hence, there is an eight times difference in acquisition time between different scanning regimes. Therefore it is seen, that the sensed image is intrinsically compressed in the technique of the invention.

FIG. 6C shows the image that would be obtained with the conventional linear scanning and with 32 equidistant exposures, or alternatively, with a 2D sensor having 256×32 pixels. It is evident, that many details that are preserved in FIG. 6B are missing in FIG. 6C. Even efficient post-processing of FIG. 6C, while yielding FIG. 6D, did not reveal details that are seen in FIG. 6B.

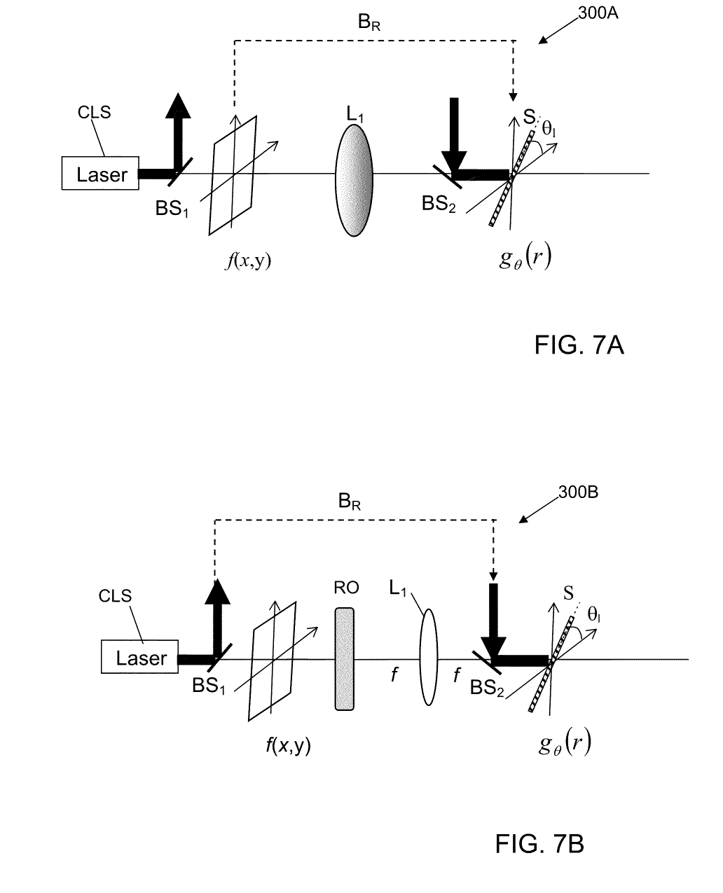

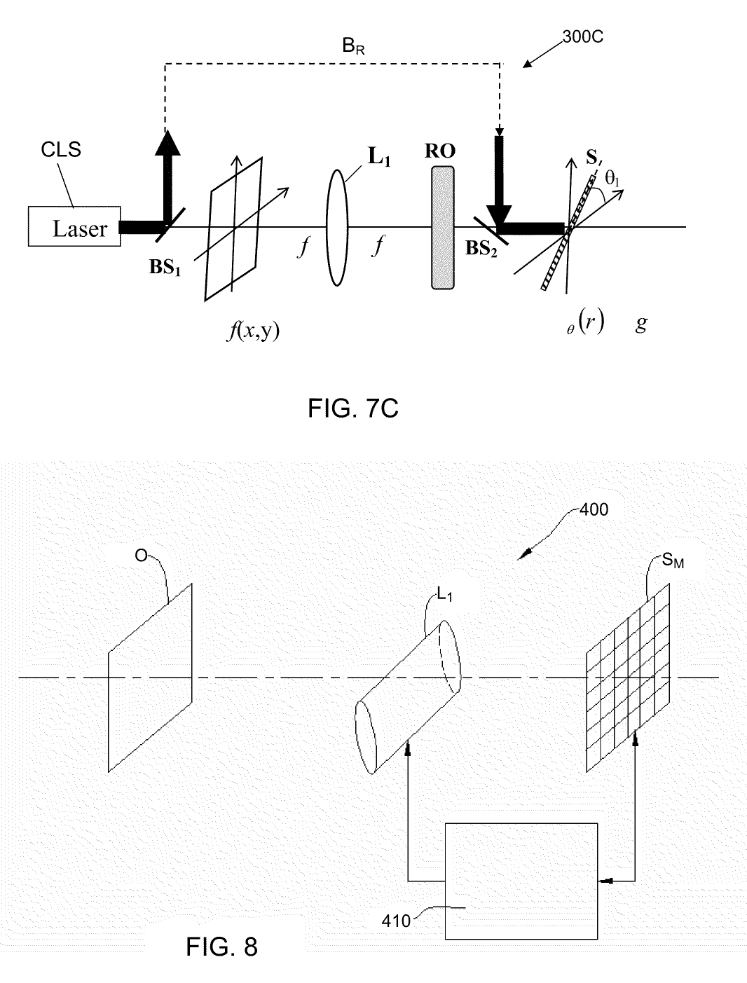

Referring to FIG. 7A, there is schematically presented an imaging system 300A implementing a Fourier digital holographic scheme for measurements of complex Fourier spectrum. System 300 is to be used with coherent light. It includes a coherent light source CLS, beam splitters BS₁ and BS₂, a lens L₁, sensor S, and optics that makes a reference beam B_{R} propagate from beam splitter BS₁ to beam splitter BS₂ (the latter optics is not shown). Coherent illumination of the light source is reflected from the object (which is not shown) and results in creation of object field f(x,y). Lens L₁ is positioned to perform the 2D-Fourier transform of field f(x,y) and distances between the object plane and the lens and between the lens and the sensor are equal to the lens focal length. Hence, sensor S measures the encoded Fourier field g_{θ}_{ₗ}(r)=ℑ_{ω}{F(ω,θₗ)} after mixing with the reference beam. The type of encoding depends on the type of holography—as described for example in J. W. Goodman, “Introduction to Fourier optics”, (McGraw-Hill, second. ed. NY, 1996).

The phase shift interferometer technique, or any other on-line or off-line holographic technique can be used [see for example J. W. Goodman, “Introduction to Fourier optics”, chapter 9]. By this method the sensor measures directly the (encoded) Fourier radial spectrum g_{θ}(r)=ℑ_{ω}{F(ω,θₗ}.

It should be noted with respect to holographic schemes, that in such measurements the well known property of conjugate symmetry of Fourier transform of real objects may be utilized: thanks to this property, only half of the complex Fourier coefficients need to be measured. This can be implemented, for example, by using a vector sensor of half size performing a rotational motion of 180° around an axis passing at one of its edges.

Holographic schemes, and more generally the technique of the invention, can as well work with various Fourier-related transforms, for example with the Fresnel transform.

As indicated above, relative rotation between an imaged scene (or an object, presented by object field f(x,y))) and the sensor plane may be obtained by rotation of the sensor plane (by angle θₗ), i.e. rotation of the sensor S (and its associated optics), and/or of the object and/or rotation of the image itself. For example, the image can be rotated optically using a prism and/or mirror using relay optics, while the sensor may be kept static. This is exemplified in FIG. 7B.

FIG. 7B shows an imaging system 300B which is configured generally similar to the above-described system 300A, namely includes a coherent light source CLS, beam splitters BS₁ and BS₂, a lens L₁, sensor S, optics producing the reference beam B_{R} propagation from beam splitter BS₁ to beam splitter BS₂. The system 300B distinguishes from system 300A in that it is configured for optically rotating the image (which may be an alternative or addition to the sensor rotation). To this end, system 300B additionally includes relay optic unit RO accommodated between the object field f(x,y) and the lens L₁ producing an image at back focal plane f of the lens L₁. Thus, object field f(x,y) is appropriately rotated and the 2D-Fourier transform is applied (by lens L₁) to the so-rotated field. The relay optics RO may include standard optical components that operate together to apply some optical effects to the object field while rotating the field, such image magnification, reduction of aberrations, etc.); such effects are thus applied at the input to the optical Fourier subsystem (2f system). Hence, sensor S detects the rotated and encoded Fourier field, g′_{θ}(r), g′_{θ}_{ₗ}(r)=ℑ_{ω}{F(ω,θₗ)} after mixing with the reference beam.

Reference is made to FIG. 7C showing an imaging system 300C which is configured generally similar to the above-described systems 300A and 300B, namely includes a coherent light source CLS, beam splitters BS₁ and BS₂, a lens L₁, sensor S, optics producing the reference beam B_{R} propagation from beam splitter BS₁ to beam splitter BS₂. The system 300C distinguishes from system 300B in that, in this configuration, the relay optics unit RO focuses (i.e. has its input object plane) at the output of the 2f optical Fourier transformer and therefore the relay optics unit is accommodated between the lens L₁ and the sensor S and is placed in a front focal plane f of the lens L₁.

Referring to FIG. 8, there is schematically shown an imaging system 400 using a pixel matrix sensor S_{M} and operating with incoherent light. System 400 includes the same optics as system 200. It is equipped with an appropriate control unit 410, which controls rotative cylindrical lens L₁ and read-out process from pixel matrix sensor S_{M}. The control unit may be based on, for example, a special purpose computing device or a specially programmed general task computer. It should be understood, that in other embodiments control can be provided as well when desired.

The reconstruction can be carried out by other optimization technique than the above-mentioned total variation minimization optimization technique. In general, any a-priory knowledge or assumption about the object features can be incorporated into used optimization technique. For common images, high quality results are expected from searches of reconstructed images with minimum complexity. For example, high quality reconstruction may be obtained by using l₁ minimization techniques, or by using maximum entropy criterion, or maximum apriori methods with generalized Gaussian priors, or wavelet “pruning” methods. As well, the reconstruction may rely on the maximum a-posteriori estimation techniques or the penalized maximum likelihood estimation techniques.

The above-mentioned total variation minimization may be viewed as an l₁ minimization of the gradient together with the assumption that the images to be captured are relatively smooth. Techniques of l₁ minimization may be especially convenient, when they can be efficiently implemented by using “linear programming” algorithms—see E. J. Candes, J. Romberg and T. Tao, “Robust uncertainty Principles: Exact signal reconstruction from highly incomplete frequency information”; D. L. Donoho, “Compressed Sensing”, IEEE Transactions on Information Theory , vol 52(4), 1289-1306, April 2006; and Y. Tsaig and D. L. Donoho, “Extensions to Compressed Sensing”, Signal Processing, vol 86, 549-571, March 2006.

The described above compressed imaging technique may utilize also algorithms for motion estimation and change detection efficiently applied to the collected data. For example, “opposite ray algorithms” may be used involving complete rotations of the line sensor (i.e. rotations for 360° rather than for 180°). In a full rotation, two frames are captured. However, motion and change can be still be estimated with only half cycle rotation, by applying tracking algorithms on the data represented as sinogram.

Additionally, the following should be noted regarding the herein described compressed imaging technique. This technique can be applied for capturing not only still images, but also video sequences. As well, within this technique, color imaging and/or imaging in various spectral ranges is allowed.

The following is an example of a method of the invention for fast video acquisition and processing/motion detection. It should be understood that, according to the conventional approach in the field of video imaging, by capturing the projection of a 2D scene with linear sensors, a complete set of projections is acquired every time in order to reconstruct a single frame and then the same procedure is repeated by sampling another disjoint set of projections in order to reconstruct the next frame. The invention enables a much faster frame acquisition rate be using a sliding window over the set of projections and update the next frame by adding the next single new projection while omitting the oldest projection in the sequence of successively captured frames.

The above concept can be used for reconstructing a 2D image and then implementing a dynamic reconstruction of a 3D image from a 2D projection, by using a sliding window for the stream of 2D projections. Thus, in the static case, for an image f(j,k), where j,k=1, . . . , n, and for an encoded Fourier field g(r,θ) where r is a point of the θ projection, we have the following relation:

g(r,Θ)=∫∫f(x,y)δ(r−cos(Θ)x−sin(Θ)y)dxdy.

For a given set of L distinct angles A={θₗ}ₗ₌₀^{L-1} in the range [0,π], the reconstruction approach used for the static case (i.e. the same reconstruction process as described above for the static case, is applied on sliding window of L projections) can be applied to reconstruct the object f from the projection set g(r,Θₗ) l=0, . . . , L−1.

In the dynamic case, the object field is presented as a function fₜ(j,k) at a certain time t, and the angle Θⱼ is a periodical expansion of the set A defined above so that θ_{j+L}=θⱼ.

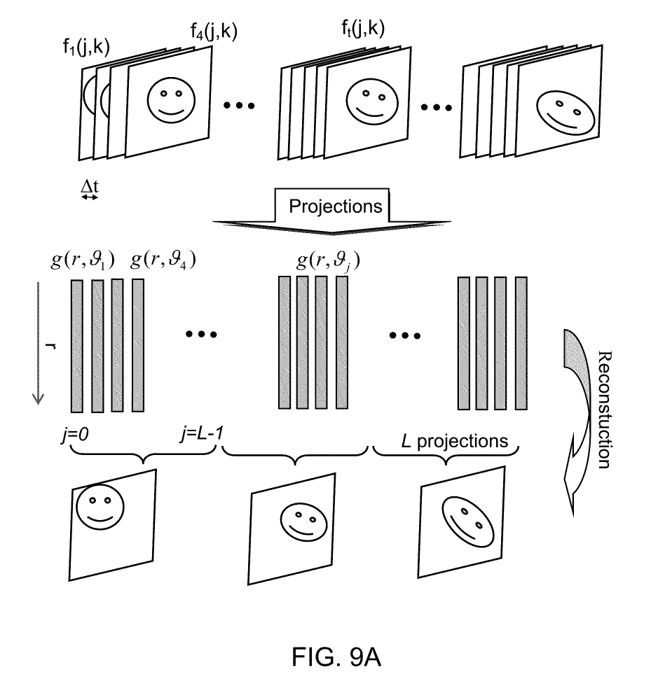

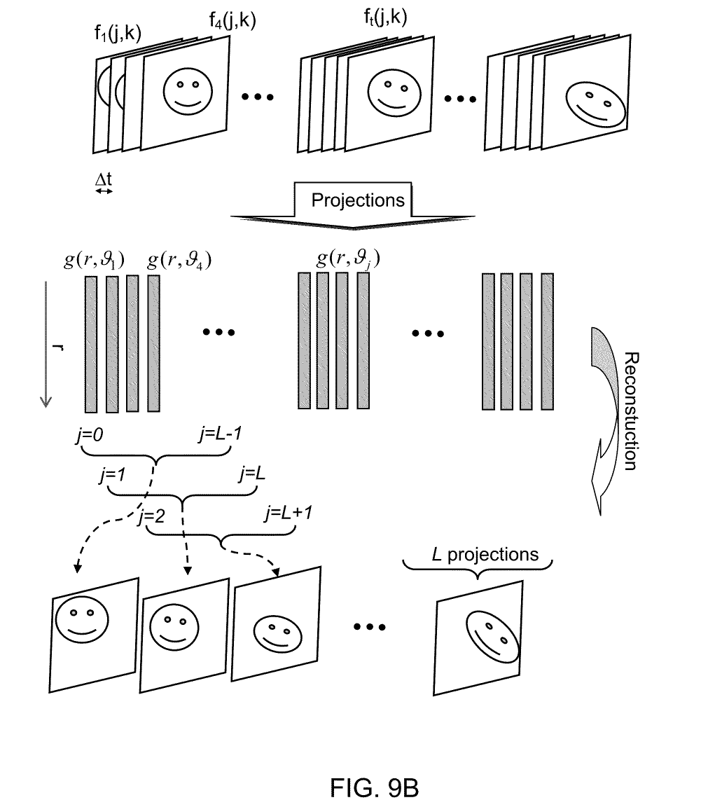

As shown in FIG. 9A, according to the conventional approach, for creating a video stream, L different projections are collected at a rate of 1/·Δt, e.g. the dynamic object scene f₁-f₄ at instants t=0, Δt, 2Δt, 4Δt is encoded to projections g(r,θ₁)−g(r,θ₄).

Then the k'th each reconstructed frame is obtained from the set:

{g(r,Θj)}, j=kL, . . . , (k+1)L−1.

The reconstructed frame rate is 1/(L·Δt), where Δt is the time between two consecutive projection acquisitions.

According to the technique of the invention, the output frame rate can be increased to 1/Δt. As exemplified in FIG. 9B, this can be implemented as follows: A 1^{st} frame in the final reconstructed stream is that reconstructed from the projection set:

{g(r,Θj)}, j=0, . . . , L−1.

The second frame is reconstructed from the set:

{g(r,Θj)}, j=1, . . . , L.

The k-th frame is reconstructed from the set:

{g(r,Θj)}, j=k−1, . . . , L+K−2.

Thus, a sliding window is applied across the set of projections. Starting from the second frame on every time the set of projections is updated by adding a single new projection and discarding the previous projection. For example, after reconstructing the k'th frame, from the set {g(r,Θj)}ⱼ₌ₖ₋₁^{L+k-2}, where k>1, the next reconstructed frame is obtained by discarding projection g(r,Θₖ₋₁) and adding the single projection g(r,Θ_{k+L-1}).

Those skilled in the art will readily appreciate that various modifications and changes can be applied to the embodiments of the invention without departing from its scope defined in and by the appended claims.

1. An imaging system for use in compressed imaging, the system comprising at least one pixel sensor having an array of pixels, and an optical unit comprising an imaging optics for projecting light, indicative of an imaged scene of an object plane on said sensor, the system being configured and operable to provide a relative rotation between the imaged scene and a sensor plane, sensed light being therefore indicative of a Fourier transform of the object plane light field at various angles of said relative rotation.

2. The system of claim 1 comprising at least two said vector sensors arranged in either a staggered configuration or a stack configuration.

3. The system of claim 1 comprising at least two vector sensors with sensitivity peak wavelengths differing for more than 20% of a shortest of said sensitivity peak wavelengths.

4. The system of claim 1, wherein the optical unit comprises a 4-f optical element arrangement; or a 2-f optical element arrangement.

5. The system of claim 1, wherein the optical unit comprises a 4-f optical element arrangement comprising at least one of a slit, a cylindrical lens, and a cylindrical mirror.

6. The system of claim 1, comprising a source of radiation for directing emitted radiation onto the object plane, the source of radiation being configured for producing coherent or incoherent radiation.

7. The system of claim 1 comprising at least one beam splitter and being configured as a holographic system.

8. The system of claim 1, wherein said at least one sensor has a sensitivity peak in at least one of the following spectral ranges: (a) between 90 GHz and 3 THz; and (b) an infrared spectral range with a frequency higher than 3 THz.

9. The system of claim 1, comprising a control unit configured to initiate measurements by said at least one sensor at predetermined angles of said relative rotation.

10. The system of claim 1, comprising a control unit configured to reconstruct an image from data measured by the sensor at various angles of said relative rotation, or at various pixel orientations within the pixel sensor.

11. The system of claim 10, wherein said control unit is configured to reconstruct the image using at least one of the following optimization techniques: (i) an algorithm configured for minimization of total variation optimization technique from data measured by the sensor for said various angles of rotation; (ii) an algorithm configured to use a maximum a posteriori estimation technique from data measured by the sensor for said various angles of rotation; (iii) an algorithm configured to use a penalized maximum likelihood estimation technique from data measured by the sensor for various angles of its rotation

12. The system of claim 1, comprising a rotative mount associated with at least one of an object, the sensor, and the optical unit for implementing said relative rotation.

13. The system of claim 1, wherein said optical unit comprises relay optics for rotating an image being projected relative to the sensor and to the object planes.

14. The system of claim 1, wherein said array of pixels is either one- or two-dimensional array.

15. The system of claim 1, configured to affect a direction of light projection onto a pixel vector of the sensor; said light projection being indicative of the 2D Fourier transform of the object plane field and to measure data indicative of the Fourier transform of the object plane light field by matching an orientation of said pixel vector within a pixel matrix of the sensor and the direction of the light projection.

16. A method for use in compressed imaging, the method comprising sequentially projecting light information, indicative of an image of an object, from an object plane on various directions and/or various angles within a pixel sensor plane and measuring data indicative of Fourier transform of the object plane field for the various directions and/or angles by a pixel vector within a pixel matrix.

17. The method of claim 16, comprising sequentially projecting said light information within a rotation plane of a sensor while rotating the sensor relatively to the object plane, so as to measure data indicative of Fourier transform of the object plane field by said sensor for the various directions of the projected light.

18. The method of claim 16, comprising reconstructing an image from said data indicative of the Fourier transform of the object plane light field, a set of spatial frequencies of the data having a star configuration in two-dimensional spatial frequency space, an envelope of the star being of a substantially circular shape.

19. The method of claim 16, comprising at least one of the following optimization algorithms: (i) using minimization of total variation optimization technique; (ii) using a maximum a posteriori estimation technique, (iii) using a penalized maximum likelihood estimation technique.

20. The method of claim 18, wherein a ratio between a length of a shortest star ray and a length of a longest ray is less than 0.65 or larger than 0.75.
